(19) United States
(12) Patent Application Publication
(10) Pub. No.: US 2008/0096988 A1
(43) Pub. Date: Apr. 24, 2008

(54) Expandable Styrene Polymers With Halogen-Free Flame Retardancy

(75) Inventors: Klaus Hahn, Kirchheim (DE); Gerd Ehrmann, Deidesheim (DE); Joachim Ruch, Wachenheim (DE); Markus Allmendinger, Deggingen (DE); Bernhard Schmied, Frankenthal (DE)

Correspondence Address: CONNOLLY BOVE LODGE & HUTZ LLP, 1875 EYE STREET, N.W., SUITE 1100, WASHINGTON, DC, 20036, US

(73) Assignee: BASF Aktiengesellschaft, Ludwigshafen (DE)

(21) Appl. No.: 11/720,563

(22) PCT Filed: Dec. 1, 2005
(86) PCT No.: PCT/EP05/12798

§ 371 Date: May 31, 2007

(30) Foreign Application Priority Data
Dec. 3, 2004 (DE) 102004058586.5

(51) Int. Cl. C08J 9/16; C08J 9/228

(52) U.S. Cl. 521/56

(57) ABSTRACT

Expandable styrene polymer granules with halogen-free flame retardancy, comprising a) from 5 to 50% by weight of a filler selected from pulverulent inorganic substances such as talc, chalk, kaolin, aluminum hydroxide, aluminum nitrite, aluminum silicate, barium sulfate, calcium carbonate, titanium dioxide, calcium sulfate, silica, quartz flour, aerosil, alumina or wollastonite, and b) from 2 to 40% by weight of expandable graphite having a mean particle size in the range from 10 to 1000 μm, c) from 0 to 20% by weight of red phosphorus or an organic or inorganic phosphate, phosphite or phosphonate, d) from 0 to 10% by weight of carbon black or graphite, and processes for their preparation and use for preparing self-extinguishing polystyrene particle foams.

The invention relates to expandable styrene polymer granules with halogen-free flame retardancy, comprising
a) from 5 to 50% by weight of a filler selected from pulverulent inorganic substances such as talc, chalk, kaolin, aluminum hydroxide, aluminum nitrite, aluminum silicate, barium sulfate, calcium carbonate, titanium dioxide, calcium sulfate, silica, quartz flour, aerosil, alumina or wollastonite, and
b) from 2 to 40% by weight of expandable graphite having a mean particle size in the range from 10 to 1000 μm,
c) from 0 to 20% by weight of red phosphorus or an organic or inorganic phosphate, phosphite or phosphonate,
d) from 0 to 10% by weight of carbon black or graphite.

Expandable styrene polymers comprising halogen-free flame retardants are known. According to EP-A 0 834 529, the flame retardant used is at least 12% by weight of a mixture of a phosphorus compound and a water-eliminating metal hydroxide, for example triphenyl phosphate and magnesium hydroxide, in order to obtain foams which pass the B2 fire test to DIN 4102.

WO 00/34342 describes expandable styrene polymers which comprise, as a flame retardant, from 5 to 50% by weight of expandable graphite and, if appropriate, from 2 to 20% by weight of a phosphorus compound.

In order to achieve sufficient flame retardancy, it is generally necessary in the case of halogen-free flame retardants to use very large amounts of expensive feedstocks.

It was therefore an object of the present invention to find inexpensive and effective, halogen-free flame retardancy for expandable styrene polymers. Accordingly, the above-described expandable styrene polymer granules have been found.

Preferred expandable styrene polymer granules comprise, as component c), from 1 to 10% by weight of red phosphorus, triphenyl phosphate or 9,10-dihydro-9-oxa-10-phosphaphenanthrene 10-oxide, and, as component d), a graphite, other than expandable graphite, which is effective as an IR absorber and has a mean particle size in the range from 0.1 to 100 μm in amounts of from 0.1 to 5% by weight.

In addition, particle foam moldings, obtainable by fusing prefoamed foam particles composed of expandable filler-comprising thermoplastic polymer granules have been found, the particle foam having a density in the range from 8 to 200 g/l, preferably in the range from 10 to 50 g/l.

Surprisingly, the inventive particle foam moldings, in spite of the presence of fillers, have a high closed-cell content, with generally more than 60%, preferably more than 70%, more preferably more than 80%, of the cells of the individual foam particles being closed-cell.

Useful fillers include organic and inorganic powders or fibrous materials, and also mixtures thereof. The organic fillers used may, for example, be wood flour, starch, or flax, hemp, ramie, jute, sisal, cotton, cellulose or aramid fibers. The inorganic fillers used may, for example, be carbonates, silicates, barite, glass spheres, zeolites or metal oxides. Preference is given to pulverulent inorganic substances such as talc, chalk, kaolin (Al₂(Si₂O₅)(OH)₄), aluminum hydroxide, magnesium hydroxide, aluminum nitrite, aluminum silicate, barium sulfate, calcium carbonate, calcium sulfate, silica, quartz flour, aerosil, alumina or wollastonite, or spherical or fibrous inorganic substances such as glass spheres, glass fibers or carbon fibers.

The mean particle diameter or, in the case of fibrous fillers, the length should be in the region of the cell size or smaller. Preference is given to a mean particle diameter in the range from 1 to 100 μm, preferably in the range from 2 to 50 μm.

Particular preference is given to inorganic fillers having a density in the range from 2.0 to 4.0 g/cm³, in particular in the range from 2.5 to 3.0 g/cm³. The whiteness/brightness (DIN/ISO) is preferably from 50 to 100%, in particular from 70 to 98%. The oil number to ISO 787/5 of the preferred fillers is in the range from 2 to 200 g/100 g, in particular in the range from 5 to 150 g/100 g.

The type and amount of the fillers allows the properties of the expandable thermoplastic polymers and the particle foam moldings obtainable therefrom to be influenced. The proportion of the filler is generally in the range from 1 to 50% by weight, preferably from 5 to 30% by weight, based on the thermoplastic polymer. At filler contents in the range from 5 to 15% by weight, no significant deterioration in the mechanical properties of the particle foams, such as flexural strength or compressive strength, is observed. The use of adhesion promoters, such as maleic anhydride-modified styrene copolymers, epoxy-containing polymers, organosilanes or styrene copolymers with isocyanate or acid groups, allows the binding of the filler to the polymer matrix and thus the mechanical properties of the particle foam moldings to be distinctly improved.

In general, inorganic fillers reduce the combustibility. Especially by use of inorganic powders, such as aluminum hydroxide, the fire performance can be distinctly improved.

Surprisingly, the inventive thermoplastic polymer granules exhibit low loss of blowing agent in the course of storage even at high filler contents. Owing to the nucleating action, it is also possible to reduce the blowing agent content based on the polymer.

The thermoplastic polymers used may, for example, be styrene polymers, polyamides (PA), polyolefins such as polypropylene (PP), polyethylene (PE) or polyethylene-propylene copolymers, polyacrylates such as polymethyl methacrylate (PMMA), polycarbonate (PC), polyesters such as polyethylene terephthalate (PET) or polybutylene terephthalate (PBT), polyether sulfones (PES), polyether ketones or polyether sulfides (PES) or mixtures thereof. Particular preference is given to using styrene polymers.

It has been found that styrene polymers having molecular weights M_{w} of below 160 000 lead to polymer attrition in the course of granulation. The expandable styrene polymer has a molecular weight preferably in the range from 190 000 to 400 000 g/mol, more preferably in the range from 220 000 to 300 000 g/mol. Owing to the molecular weight degradation by shearing and/or thermal action, the molecular weight of the expandable polystyrene is generally about 10 000 g/mol below the molecular weight of the polystyrene used.

In order to obtain granule particles of minimum size, the die swell downstream of the die outlet should be minimized. It has been found that the die swell can be influenced by factors including the molecular weight distribution of the styrene polymer. The expandable styrene polymer should therefore preferably have a molecular weight distribution with a polydispersity M_{w}/Mₙ of at most 3.5, more preferably in the range from 1.5 to 2.8 and most preferably in the range from 1.8 to 2.6.

The styrene polymers are preferably used in the form of glass-clear polystyrene (GPPS), high-impact polystyrene (HIPS), anionically polymerized polystyrene or high-impact polystyrene (A-IPS), styrene-α-methylstyrene copolymers, acrylonitrile-butadiene-styrene polymers (ABS), styrene-acrylonitrile (SAN), acrylonitrile-styrene-acrylic ester (ASA), methyl acrylate-butadiene-styrene (MBS), methyl methacrylate-acrylonitrile-butadiene-styrene (MABS) polymers, or mixtures thereof or with polyphenylene ether (PPE).

To improve the mechanical properties or the thermal stability, the styrene polymers mentioned may, if appropriate with use of compatibilizers, be blended with thermoplastic polymers, such as polyamides (PA), polyolefins such as polypropylene (PP) or polyethylene (PE), polyacrylates such as polymethyl methacrylate (PMMA), polycarbonate (PC), polyesters such as polyethylene terephthalate (PET) or polybutylene terephthalate (PBT), polyether sulfones (PES), polyether ketones or polyether sulfides (PES), or mixtures thereof, generally in total proportions up to a maximum of 30% by weight, preferably in the range from 1 to 10% by weight, based on the polymer melt. In addition, mixtures within the ranges of amounts mentioned are also possible with, for example, hydrophobically modified or functionalized polymers or oligomers, rubbers such as polyacrylates or polydienes, for example styrene-butadiene block copolymers, or biodegradable aliphatic or aliphaticlaromatic copolyesters.

Suitable compatibilizers are, for example, maleic anhydride-modified styrene copolymers, epoxy-containing polymers or organosilanes.

It is also possible for polymer recyclates of the thermoplastic polymers mentioned, in particular styrene polymers and expandable styrene polymers (EPS) to be added to the styrene polymer melt in amounts which do not significantly worsen their properties, generally in amounts of not more than 50% by weight, in particular in amounts of from 1 to 20% by weight.

The blowing agent-containing styrene polymer melt comprises generally one or more blowing agents in homogeneous distribution in a total proportion of from 2 to 10% by weight, preferably from 3 to 7% by weight, based on the blowing agent-containing styrene polymer melt. Suitable blowing agents are the physical blowing agents used typically in EPS, such as aliphatic hydrocarbons having from 2 to 7 carbon atoms, alcohols, ketones, ethers or halogenated hydrocarbons. Preference is given to using isobutane, n-butane, isopentane, n-pentane.

To improve the foamability, finely dispersed internal water droplets can be introduced into the styrene polymer matrix. This can be done, for example, by the addition of water to the molten styrene polymer matrix. The water can be added upstream of, with, or downstream of the blowing agent metering. A homogeneous distribution of the water can be achieved by means of dynamic or static mixers.

In general, from 0 to 2% by weight, preferably from 0.05 to 1.5% by weight, of water, based on the styrene polymer, are sufficient.

Expandable styrene polymers (EPS) with at least 90% of the internal water in the form of internal water droplets with a diameter in the range from 0.5 to 15 μm form, when foamed, foams with sufficient cell number and homogeneous foam structure.

The amount of blowing agent and water added is selected such that the expandable styrene polymers (EPS) have an expansion capacity α, defined as the bulk density before the foaming/bulk density after the foaming, of at most 125, preferably from 25 to 100.

The inventive expandable styrene polymer granules (EPS) generally have a bulk density of at most 700 g/l, preferably in the range from 590 to 660 g/l. When fillers are used, bulk densities in the range from 590 to 1200 g/l can occur depending on the type and amount of filler.

Furthermore, in addition to the fillers, it is possible to add to the styrene polymer melt additives, nucleating agents, plasticizers, flame retardants, soluble and insoluble inorganic and/or organic dyes and pigments, for example IR absorbers such as carbon black, graphite or aluminum powder, together or spatially separately, for example via mixers or side extruders. In general, the dyes and pigments are added in amounts in the range from 0.01 to 30% by weight, preferably in the range from 1 to 5% by weight. For the homogeneous and microdispersed distribution of the pigments in the styrene polymer, it may be appropriate, especially in the case of polar pigments, to use a dispersing assistant, for example organosilanes, epoxy-containing polymers or maleic anhydride-grafted styrene polymers. Preferred plasticizers are mineral oils, low molecular weight styrene polymers, phthalates which can be used in amounts of from 0.05 to 10% by weight based on the styrene polymer.

Fillers with particle sizes in the range from 0.1 to 100 μm, in particular in the range of 0.5 to 10 μm, give rise, in the polystyrene foam, at contents of 10% by weight, to a reduction in the thermal conductivity by from 1 to 3 mW. Therefore, even with small amounts of IR absorbers, such as carbon black and graphite, comparatively low thermal conductivities can be achieved.

Preference is given to reducing the thermal conductivity by using an IR absorber, such as carbon black or graphite, in amounts of from 0.1 to 10% by weight, in particular in amounts of from 2 to 8% by weight.

When smaller amounts of filler are used, for example below 5% by weight, it is also possible to use carbon black in amounts of from 1 to 25% by weight, preferably in the range from 10 to 20% by weight. At these high carbon black contents, the carbon black addition is preferably mixed into the styrene polymer melt divided between the main stream and a side stream extruder. The addition via extruders enables simple comminution of the carbon black agglomerates to a mean agglomerate size in the range from 0.3 to 10 μm, preferably in the range from 0.5 to 5 μm, and homogeneous coloring of the expandable styrene polymer granules which can be foamed to closed-cell foam particles having a density in the range of 5-40 kg/m³, in particular 10-15 kg/m³. The particle foams obtainable with from 10 to 20% by weight of carbon black after foaming and sintering attain a thermal conductivity λ, determined at 10° C. to DIN 52612, in the range from 30 to 33 mW/mK.

Preference is given to using carbon black with a mean primary particle size in the range from 10 to 300 nm, in particular in the range from 30 to 200 nm. The BET surface area is preferably in the range from 10 to 120 m²/g.

The graphite used is preferably graphite having a mean particle size in the range from 1 to 50 μm.

To prepare the inventive expandable styrene polymers, the blowing agent is mixed into the polymer melt. The process comprises the stages a) melt generation, b) mixing, c) cooling, d) conveying and e) granulating. Each of these stages can be performed by the apparatus or apparatus combinations known in plastics processing. Suitable apparatus for mixing-in is static or dynamic mixers, for example extruders. The polymer melt can be removed directly from a polymerization reactor or generated directly in the mixing extruder or a separate melting extruder by melting of polymer granules. The melt can be cooled in the mixer units or in separate coolers. Useful apparatus for the granulation is, for example, pressurized underwater granulation, granulation with rotating blades and cooling by spray atomization of temperature-control liquids or 20, atomization granulation. Suitable apparatus arrangements for carrying out the process are, for example:

a) polymerization reactor—static mixer/cooler—granulator

b) polymerization reactor—extruder—granulator

c) extruder—static mixer—granulator

d) extruder—granulator

In addition, the arrangement can have side extruders for incorporating additives, for example solids or thermally sensitive additives.

The blowing agent-containing styrene polymer melt is conveyed through the die plate generally with a temperature in the range from 140 to 300° C., preferably in the range from 160 to 240° C. Cooling down to the region of the glass transition temperature is not necessary.

The die plate is heated at least to the temperature of the blowing agent-containing polystyrene melt. The temperature of the die plate is preferably in the range from 20 to 100° C. above the temperature of the blowing agent-containing polystyrene melt. This prevents polymer deposits in the dies and ensures disruption-free granulation.

In order to obtain marketable granule sizes, the diameter (D) of the die bores at the die outlet should be in the range from 0.2 to 1.5 mm, preferably in the range from 0.3 to 1.2 mm, more preferably in the range from 0.3 to 0.8 mm. This allows granule sizes below 2 mm, in particular in the range from 0.4 to 1.4 mm to be attained in a controlled manner even after die swell.

Apart from by the molecular weight distribution, the die swell can be influenced by the die geometry. The die plate preferably has bores having an L/D ratio of at least 2, where the length (L) denotes the die region whose diameter corresponds at most to the diameter (D) at the die outlet. The L/D ratio is preferably in the range of 3-20.

In general, the diameter (E) of the bores at the die inlet of the die plate should be at least twice as large as the diameter (D) at the die outlet.

One embodiment of the die plate has bores with conical inlet and an inlet angle α of less than 180°, preferably in the range from 30 to 120°. In a further embodiment, the die plate has bores with conical outlet and an outlet angle β of less than 90°, preferably in the range from 15 to 45°. In order to obtain controlled granule size distributions of the styrene polymers, the die plate can be equipped with bores of different outlet diameter (D). The different embodiments of the die geometry can also be combined with one another.

A particularly preferred process for preparing expandable styrene polymers comprises the steps of
a) polymerizing styrene monomer and, if appropriate, copolymerizable monomers,
b) degassing the resulting styrene polymer melt,
c) mixing the blowing agent and, if appropriate, additives into the styrene polymer melt by means of static or dynamic mixers at a temperature of at least 150° C., preferably 180-260° C.,
d) cooling the blowing agent-containing styrene polymer melt to a temperature which is at least 120° C., preferably 150-200° C.,
e) adding the filler,
f) discharge through a die plate with bores whose diameter at the die outlet is at most 1.5 mm and
g) granulating the blowing agent-containing melt.

In step g), the granulation can be effected directly beyond the die plate under water at a pressure in the range from 1 to 25 bar, preferably from 5 to 15 bar.

Owing to the polymerization in stage a) and degassing in stage b), a polymer melt is available directly in stage c) for the blowing agent impregnation, and there is no need to melt styrene polymers. This is not only more economically viable but also leads to expandable styrene polymers (EPS) with low styrene monomer contents, since the mechanical shear action in the melting region of an extruder, which generally leads to dissociation of monomers, is avoided. In order to keep the styrene monomer content low, especially below 500 ppm with styrene monomer contents, it is also appropriate to keep the mechanical and thermal energy input as low as possible in all subsequent process stages. Particular preference is therefore given to maintaining shear rates below 50/sec, preferably from 5 to 30/sec, and temperatures below 260° C., and also short residence times in the range from 1 to 20 minutes, preferably from 2 to 10 minutes, in stages c) to e). Particular preference is given to using exclusively static mixers and static coolers in the overall process. The polymer melt can be conveyed and discharged by pressure pumps, for example gear pumps.

A further means of reducing the styrene monomer content and/or residual solvents such as ethylbenzene consists in providing, in stage b), high-level degassing by means of entraining agents, for example water, nitrogen or carbon dioxide, or carrying out the polymerization stage a) anionically. The anionic polymerization of styrene leads not only to styrene polymers with low styrene monomer content, but simultaneously to low styrene oligomer contents.

To improve the processability, the finished expandable styrene polymer granules can be coated by glycerol esters, antistats or anticaking agents.

Depending on the filler type and content, the inventive expandable styrene polymer granules (EPS) generally have relatively high bulk densities which are generally in the range from 590 to 1200 g/l.

The inventive expandable thermoplastic polymer granules exhibit good expansion capacity even at low blowing agent contents. Even without coating, caking is distinctly lower than in the case of conventional EPS beads.

Owing to its layered lattice structure, graphite is capable of forming specific forms of inclusion compounds. In these so-called interstitial compounds, extraneous atoms or molecules are accommodated, sometimes in stoichiometric ratios, into the spaces between the carbon atoms. These graphite compounds, for example with sulfuric acid as an extraneous molecule, which are also prepared on the industrial scale, are referred to as expandable graphite. The density of this expandable graphite is in the range from 1.5 to 2.1 g/cm³; the mean particle size is generally appropriately from 10 to 1000 μm, in the present case preferably from 20 to 500 μm and in particular from 30 to 300 μm.

The phosphorus compounds used may be inorganic or organic phosphates, phosphites or phosphonates, and also red phosphorus. Preferred phosphorus compounds are, for example, diphenyl phosphate, triphenyl phosphate, diphenyl cresyl phosphate, ammonium polyphosphate, resorcinol diphenylphosphate, melamine phosphate, dimethyl phenylphosphonate or dimethyl methylphosphonate.

The inventive expandable styrene polymer granules can be prefoamed by means of hot air or steam to give foam particles having a density in the range from 8 to 200 kg/m³, preferably in the range from 10 to 50 kg/m³, and subsequently fused in a closed mold to give foam moldings.

Owing to the synergistic action of fillers, such as chalk with expandable graphite and red phosphorus or a phosphorus compound, inexpensive, halogen-free flame retardancy can be achieved.

### EXAMPLES

7% by weight of n-pentane were mixed into a polystyrene melt composed of PS 148G from BASF Aktiengesellschaft with a viscosity number VN of 83 ml/g (M_{w}=220 000 g/mol, polydispersity M_{w}/Mₙ=2.9). After the blowing agent-containing melt had been cooled from originally 260° C. to a temperature of 190° C., a polystyrene melt which the fillers mentioned in table 1 (chalk) and the appropriate flame retardant mixture (expandable graphite: ES 350 F5 from Kropfmühl, red phosphorus, triphenyl phosphate (TPP) or 9,10-dihydro-9-oxa-10-phosphaphenanthrene 10-oxide (DOP)) was added via a sidestream extruder, and mixed into the main stream. The amounts reported in % by weight are based on the total amount of polystyrene.

The mixture of polystyrene melt, blowing agent, filler and flame retardant was conveyed at 60 kg/h through a die plate with 32 bores (diameter of the die 0.75 mm). With the aid of pressurized underwater granulation, compact granules with narrow size distribution were prepared.

These granules were prefoamed in flowing steam to give foam beads having a density in the range of 10-15 kg/m³, stored for 24 hours and subsequently fused in gas-tight molds with steam to give foam moldings.

Before the fire performance and the thermal conductivity λ (determined at 10° C. to DIN 52612) were examined, the specimens were stored for at least 72 hours. Examples 1-4 were self-extinguishing and passed the B2 fire test to DIN 4102.

TABLE 1

| | | Expandable | Phosphorus | | Thermal |
|---|---|---|---|---|---|
| Exam- | Chalk | graphite | (compound) | Density | conductivity |
| ple | [% by wt.] | [% by wt.] | [% by wt.] | [kg/m³] | [mW/m*K] |
| 1 | 5 | 6 | 4, red | 12.5 | 36.0 |
| | | | phosphorus | | |
| | | | 1.5 TPP | | |
| 2 | 10 | 6 | 6, red | | |
| | | | phosphorus | | |
| 3 | 5 | 10 | 6 TPP | 12.7 | 34.5 |
| 4 | 5 | 6 | 6 DOP | | |

What is claimed is:

1. An expandable styrene polymer granule comprising
a) from 5 to 50% by weight of a filler selected from pulverulent inorganic substances such as talc, chalk, kaolin, aluminum hydroxide, aluminum nitrite, aluminum silicate, barium sulfate, calcium carbonate, titanium dioxide, calcium sulfate, silica, quartz flour, aerosil, alumina or wollastonite, and
b) from 2 to 40% by weight of expandable graphite having a mean particle size in the range from 10 to 1000 μm,
c) from 0 to 20% by weight of red phosphorus or an organic or inorganic phosphate, phosphite or phosphonate,
d) from 0 to 10% by weight of carbon black or graphite.

2. The expandable styrene polymer granule according to claim 1, which comprises from 1 to 10% by weight of red phosphorus, triphenyl phosphate or 9,10-dihydro-9-oxa-10-phosphaphenanthrene 10-oxide.

3. The expandable styrene polymer granule according to claim 2, which comprises from 0.1 to 5% by weight of graphite having a mean particle size in the range from 0.1 to 100 μm.

4. The expandable styrene polymer granule according to claim 1, which comprises from 3 to 7% by weight of an organic blowing agent.

5. A process for preparing expandable styrene polymers, comprising the steps of
a) mixing
(i) an organic blowing agent,
(ii) 5-50% by weight, based on the styrene polymer, of a filler, selected from pulverulent inorganic substances such as talc, chalk, kaolin, aluminum hydroxide, aluminum nitrite, aluminum silicate, barium sulfate, calcium carbonate, titanium dioxide, calcium sulfate, silica, quartz flour, aerosil, alumina or wollastonite, and
(iii) from 2 to 40% by weight, based on the styrene polymer, of expandable graphite having a mean particle size in the range from 10 to 1000 μm into the styrene polymer melt by means of static or dynamic mixers at a temperature of at least 150° C.,
b) cooling the blowing agent- and filler-containing polymer melt to a temperature of at least 120° C.,
c) discharging through a die plate with bores whose diameter at the die outlet is at most 1.5 mm and
d) granulating the blowing agent-containing melt directly beyond the die plate under water at a pressure in the range from 1 to 20 bar.

6. A process for producing particle foam moldings, which comprises prefoaming expandable styrene polymer granules according to claim 1 in a first step by means of hot air or steam to give foam particles having a density in the range from 8 to 200 g/l and, in a second step, fusing them in a closed mold.

7. The expandable styrene polymer granule according to claim 2, which comprises from 3 to 7% by weight of an organic blowing agent.

8. The expandable styrene polymer granule according to claim 3, which comprises from 3 to 7% by weight of an organic blowing agent.
